(19) United States
(12) Patent Application Publication
(10) Pub. No.: US 2012/0214928 A1
(43) Pub. Date: Aug. 23, 2012

(54) WATERBORNE COMPOSITIONS AND THEIR USE AS PAINTS AND STAINS

(75) Inventors: Narayan K. Raman, Pittsburgh, PA (US); Robert T. Pogue, Pittsburgh, PA (US); Melissa Lynn Billeck, Pittsburgh, PA (US); Kaliappa Ragunathan, Gibsonia, PA (US)

(73) Assignee: PPG IDUSTRIES OHIO, INC., Cleveland, OH (US)

(21) Appl. No.: 13/033,007

(22) Filed: Feb. 23, 2011

(51) Int. Cl. C08L 43/04; C08K 3/22; C08L 67/02

(52) U.S. Cl. 524/431; 524/547; 524/601; 524/430; 524/432

(57) ABSTRACT

Waterborne compositions comprising an aqueous dispersion comprising a latex are disclosed. Disclosed are latexes that are the reaction product of reactants that include a ureido-functional ethylenically unsaturated compound, an ethylenically unsaturated silicone, and another ethylenically unsaturated compound. Use of such composition to treat porous substrate is also disclosed.

### FIELD OF THE INVENTION

The present invention relates to, among other things, waterborne compositions, methods for using such compositions, and substrates, such as wood-containing substrates, at least partially coated with such compositions.

### BACKGROUND OF THE INVENTION

The use of water-based emulsion polymer systems, i.e., latexes, in paint and stains is known. One problem that has historically plagued latex paints and stains is their inability to adhere well to substrates, such as wood substrates, when under wet conditions. The term “wet adhesion” is used to describe the ability of a coating to retain its adhesive bond under such conditions. Poor “wet adhesion” (at least relative to oil-based paints) has, therefore, historically imposed limits on the usefulness of latex paints and stains.

As will be appreciated, paints and stains subjected to outdoor use are frequently exposed to moisture due to rain and high humidity. Similar “wet” conditions can also be faced by interior paints and stains. Therefore, it is desired to improve the wet adhesion properties of latex paints and stains without detrimentally affecting (or even improving) other important properties, such as water resistance.

### SUMMARY OF THE INVENTION

In certain respects, the present invention is directed to waterborne compositions, such as, for example, opaque paints and translucent stains and sealants. These compositions comprise an aqueous dispersion comprising a latex comprising the reaction product of reactants comprising: (a) a ureido-functional ethylenically unsaturated compound; (b) an ethylenically unsaturated silicone; and (c) an ethylenically unsaturated compound different from (a) and (b).

The present invention also relates to, inter alia, methods of using waterborne compositions that comprise depositing the composition over at least a portion of a substrate, such as a wood substrate, as well as substrates, such as wood substrates, at least partially coated with an opaque paint or translucent stain or sealant, deposited from such waterborne compositions.

In other respects, the present invention is directed to methods for treating a porous substrate, such as substrate comprising wood, with a waterborne composition comprising an aqueous dispersion comprising: (a) polymer particles; and (b) resin-coated nanoparticles.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In certain embodiments, the present invention is directed to waterborne compositions, such as opaque paints and translucent stain or sealant compositions, suitable for application over, for example, porous substrates, such as substrates comprising wood. As used herein, the term “porous substrate” refers to substrates that contain pores or interstices that may allow a liquid composition to penetrate the surface of the substrate. As used herein, “waterborne” refers to compositions in which the solvent or carrier fluid for the composition primarily or principally comprises water. As used herein, the term “opaque paint” refers to a composition capable of producing an opaque coating on a substrate, i.e., a coating that exhibits hiding of the underlying substrate by not allowing light to pass through the coating. As used herein, the term “translucent stain” refers to a composition that can color a substrate, such as a porous substrate (like wood), while allowing some of the substrate's natural color and/or grain to show through. As used herein, the term “sealant” refers to a composition that performs a function similar to a stain in that it allows the substrate's natural color and/or grain to show through, however, a “sealant” is typically only very lightly colored or not colored at all.

The compositions of the present invention comprising an aqueous dispersion comprising a latex. As used herein, the term “latex” refers to a suspension of polymer particles in a continuous medium. In the present invention, the continuous medium primarily or principally comprises water. For example, in certain embodiments, the continuous phase is at least 80 weight percent water, based on the total weight of the carrier fluid. In certain embodiments, the amount of organic solvent present in the compositions of the present invention is less than 20 weight percent, such as less than 10 weight percent, or, in some cases, less than 5 weight percent, or, in yet other cases, less than 2 weight percent, with the weight percents being based on the total weight of the continuous phase.

As a result, certain of the compositions of the present invention are “low VOC compositions”. As used herein, the term “low VOC composition” means that the composition contains no more than three hundred (300) grams, or, in some cases, no more than two hundred and fifty (250) grams, or, in some cases, no more than one hundred (100) grams of VOC per liter of the composition. The Examples herein illustrate how to calculate the amount of VOC in a composition for purposes of the present invention. As used herein, the term “VOC” refers to compounds that have at least one carbon atom and which are released from the composition during drying and/or curing thereof. Examples of “VOC” include, but are not limited to, alcohols, benzenes, toluenes, chloroforms, and cyclohexanes, including, for example, propylene glycol monobutyl ether, ethylene glycol monohexyl ether, ethylene glycol monobutyl ether, n-butanol, benzyl alcohol, and mineral spirits.

In certain embodiments of the compositions of the present invention, the latex comprises an acrylic polymer that comprises the reaction product of a plurality of ethylenically unsaturated reactants. These reactants may comprise: (a) a ureido-functional ethylenically unsaturated compound; (b) an ethylenically unsaturated silicone; and (c) an ethylenically unsaturated compound different from (a) and (b).

As used herein, the term “ureido-functional ethylenically unsaturated compound” refers to a molecular compound that comprises, within the molecule, (i) at least one ureido group, and (ii) at least one ethylenically unsaturated carbon-carbon bond, such as carbon-carbon double bonds (C═C). As used herein, “ureido group” refers to the general structure (I):

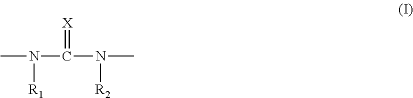

wherein: (a) X is O or S; and (b) R₁ and R₂ are each independently hydrogen, a linear or branched alkyl group containing 1 to 6 carbon atoms, a cycloalkyl group containing 5 to 15 carbon atoms, such as cyclohexyl, an aryl group containing 5 to 15 carbon atoms, such as phenyl, or an aralkyl group containing 6 to 12 carbon atoms, such as methylbenzyl, these groups optionally being substituted with one or more groups selected from halogen, amine, hydroxyl and carboxyl.

In certain embodiments, the ureido group is a “cyclic ureido group” when R₁ and R₂ are connected to each other by a single covalent bond or via an alkylene group containing 1 to 3 carbon atoms, optionally carrying one or more alkyl groups containing 1 to 4 carbon atoms, such as ethylene, propylene or trimethylene.

In certain embodiments, the ureido-functional ethylenically unsaturated compound used as a reactant in the manufacture of the latex present in certain compositions of the present invention has the general formula (II):

H₂C═C(R)ZA¹N(R¹)C(X)NR²R³ (II)

wherein: (i) R is methyl; (ii) A¹ is an alkylene group containing 2 or 3 carbon atoms, such as —CH₂—CH₂— or —CH(CH₃)CH₂—; (iii) R¹ and R² each independently represent hydrogen, a linear or branched alkyl group containing 1 to 6 carbon atoms, a cycloalkyl group containing 5 to 15 carbon atoms (such as cyclohexyl), an aryl group containing 5 to 15 carbon atoms (such as phenyl), or an aralkyl group containing 6 to 12 carbon atoms (such as methylbenzyl or benzyl), wherein R¹ and R² may be connected together by, by a single covalent bond or via an alkylene group containing 1 to 3 (such as methylene, ethylene, or propylene), optionally carrying one or more alkyl groups containing 1 to 4 carbon atoms (such as methyl, propyl or butyl); (iv) R³ is hydrogen or an alkyl group containing 1 to 8 carbon atoms, optionally interrupted by or substituted with a heteroatom (such as an O); and (v) Z and X are each independently O or S.

In some embodiments, the foregoing ureido-functional ethylenically unsaturated compound used as a reactant in the manufacture of the latex present in certain compositions of the present invention, which has the general formula (II), comprises a unit according to structure (III):

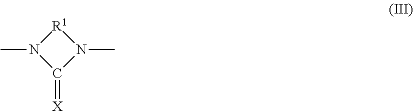

in which: (i) R¹ represents an alkylene group containing 2 to 4 carbon atoms (such as ethylene, propylene or trimethylene) optionally carrying an alkyl group containing 1 to 4 carbon atoms (such as methyl, propyl or butyl); and X is O or S.

In some embodiments, the foregoing ureido-functional ethylenically unsaturated compound used as a reactant in the manufacture of the latex present in certain compositions of the present invention, has the general formula (IV):

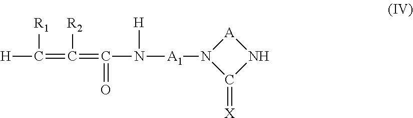

in which: (i) R₁ and R₂ each independently represent hydrogen, a linear or branched alkyl group containing 1 to 6 carbon atoms (such as methyl, propyl or butyl), a cycloalkyl group containing 5 to 8 carbon atoms, or an aryl or aralkyl group containing 6 to 12 carbon atoms, optionally carrying an alkyl group containing 1 to 4 carbon atoms (such as phenyl, methylphenyl, benzyl or methylbenzyl); (ii) A₁ and A each independently represent an alkylene group containing 2 to 4 carbon atoms (such as ethylene, propylene or trimethylene) optionally carrying an alkyl group containing 1 to 4 carbon atoms (such as methyl, propyl or butyl); and (iii) X is O or S.

Specific examples of ureido-functional ethylenically unsaturated compounds which may be used in the present invention include, without limitation, the monomers listed in U.S. Pat. No. 6,031,038 at col. 6, lines 32-46, the cited portion of which being incorporated herein by reference. In certain embodiments, such a monomer comprises N-(β-ureido ethyl)acrylamide, which has the structure (V) and which is commercially available as SIPOMER® WAM H from Rhodia, Inc.:

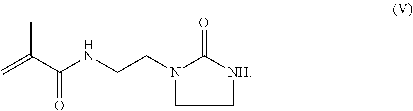

In certain embodiments, the ureido-functional ethylenically unsaturated compound is used in an amount of up to 10 percent by weight, such as up to 5 percent by weight up to 2 percent by weight, or up to 1 percent by weight, based on the total weight of reactants used to manufacture the latex present in certain compositions of the present invention. In certain embodiments, the ureido-functional ethylenically unsaturated compound is used in an amount of at least 0.1 percent by weight, such as at least 0.2 percent by weight or at least 0.4 percent by weight, based on the total weight of reactants used to manufacture the latex present in certain compositions of the present invention.

As indicated earlier, the reactants used to manufacture the latex present in certain compositions of the present invention also include an ethylenically unsaturated silicone. As used herein, the term “ethylenically unsaturated silicone” refers to a polysiloxane polymer, i.e., a polymer based on a structure comprising alternate silicon and oxygen atoms that includes at least one, in some cases two or more, ethylenically unsaturated carbon-carbon bonds, such as carbon-carbon double bonds (C═C). The one or more ethylenically unsaturated carbon-carbon bonds present on the ethylenically unsaturated silicone can, for example, be present as part of a (meth)acrylate group as described below, and can be pendant and/or terminal from the main polymer chain. In some embodiments, the ethylenically unsaturated silicone comprises no more than 5, such as no more than 2, ethylenically unsaturated carbon-carbon bonds per molecule.

In certain embodiments, the ethylenically unsaturated silicone comprises a silicone(meth)acrylate. As used herein, “(meth)acrylate” and like terms is meant to encompass both acrylates and methacrylates. In certain embodiments, the ethylenically unsaturated silicone used to manufacture the latex present in the compositions of the present invention comprises one or more pendant and/or terminal (meth)acrylate groups. In some embodiments, the ethylenically unsaturated silicon comprises a compound having the structure (VI):

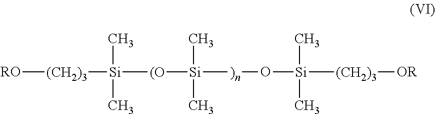

in which: (a) each R is independently H, an alkyl group, a cycloalkyl group, an aryl group, an aralkyl group, or a group comprising a (meth)acrylate, with the proviso that at least one R is a group comprising a (meth)acrylate, and (b) n is an integer having a value of 0 to 200, such as 50 to 100. In certain embodiments, each R independently has the structure (VII):

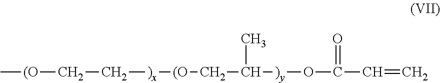

wherein the sum of x and y is 0 to 100, such as 5 to 25. Such silicone(meth)acrylates are commercially available from Siltech Corporation under the Silmer® line of reactive silicones.

In certain embodiments, the ethylenically unsaturated silicone is used in an amount of up to 10 percent by weight, such as up to 5 percent by weight, based on the total weight of reactants used to manufacture the latex present in certain compositions of the present invention. In certain embodiments, the ethylenically unsaturated silicone is used in an amount of at least 0.1 percent by weight, such as at least 0.5 percent by weight or at least 1 percent by weight, based on the total weight of reactants used to manufacture the latex present in certain compositions of the present invention.

As indicated earlier, the reactants used to manufacture the latex present in certain compositions of the present invention also include an ethylenically unsaturated compound different from the previously described ureido-functional ethylenically unsaturated compound and ethylenically unsaturated silicone. In certain embodiments, such ethylenically unsaturated compound different from the previously described ureido-functional ethylenically unsaturated compound and ethylenically unsaturated silicone is used in an amount of 80 to 99.8 percent by weight, such as 95 to 99 percent by weight, based on the total weight of the reactants used to manufacture the latex present in certain compositions of the present invention.

In certain embodiments, for example, such additional ethylenically unsaturated compound comprises a cycloaliphatic(meth)acrylate. Cycloaliphatic(meth)acrylates suitable for use in the present invention include, without limitation, trimethylcyclohexyl(meth)acrylate, t-butyl cyclohexyl(meth)acrylate, dicyclopentadiene(meth)acrylate, cyclohexyl(meth)acrylate, isobornyl(meth)acrylate, tetrahydrofurfuryl(meth)acrylate, 3,3,5-trimethylcyclohexyl(meth)acrylate, and/or 4-t-butylcyclohexyl(meth)acylate, and the like.

In certain embodiments, the cycloaliphatic(meth)acrylate is used in an amount of up to 40 percent by weight, such as up to 20 or up to 10 percent by weight, based on the total weight of reactants used to manufacture the latex present in certain compositions of the present invention. In certain embodiments, the cycloaliphatic(meth)acrylate is used in an amount of at least 1 percent by weight, such as at least 5 percent by weight, based on the total weight of reactants used to manufacture the latex present in certain compositions of the present invention.

Other ethylenically unsaturated monomers can be used as well, such as, for example, vinyl aromatic compounds, such as styrene, α-methylstyrene, vinyltoluene, p-methylstyrene, ethylvinylbenzene, vinylnaphthalene, vinylxylenes, α-methylstyrene dimer (meth)acrylate, and/or penta fluoro styrene, and the like.

In certain embodiments, the vinyl aromatic compound is used in an amount of up to 40 percent by weight, such as up to 30 percent by weight, based on the total weight of reactants used to manufacture the latex present in certain compositions of the present invention. In certain embodiments, the vinyl aromatic compound is used in an amount of at least 1 percent by weight, such as at least 10 percent by weight, based on the total weight of reactants used to manufacture the latex present in certain compositions of the present invention.

In certain embodiments, the reactants used to manufacture the latex used in certain compositions of the present invention comprises an alkyl(meth)acrylate, such as C₁-C₂₄ alkyl(meth)acrylates, in some cases C₁-C₈ alkyl(meth)acrylates, including, for example, methyl(meth)acrylate, propyl(meth)acrylate, tert-butyl(meth)acrylate, n-butyl(meth)acrylate, isobutyl(meth)acrylate, hexyl(meth)acrylate, 2-ethylhexyl(meth)acrylate, octyl(meth)acrylate, decyl(meth)acrylate, dodecyl(meth)acrylate, pentadecyl(meth)acrylate, hexadecyl(meth)acrylate, octadecyl(meth)acrylate, and/or nonadecyl(meth)acrylate, and the like.

In certain embodiments, the alkyl(meth)acrylate is used in an amount of up to 80 percent by weight, such as up to 70 percent by weight, or up to 60 percent by weight, based on the total weight of reactants used to manufacture the latex present in certain compositions of the present invention. In certain embodiments, the alkyl(meth)acrylate is used in an amount of at least 10 percent by weight, such as at least 30 percent by weight, or at least 50 percent by weight, based on the total weight of reactants used to manufacture the latex present in certain compositions of the present invention.

In certain embodiments, the reactants used to manufacture the latex used in certain compositions of the present invention comprises tert-butyl(meth)acrylate and cyclohexyl(meth)acrylate, wherein (i) the tert-butyl(meth)acrylate is used in an amount of 1 to 70 percent by weight, such as 10 to 40 percent by weight, or, in some cases 20 to 30 percent by weight, and (ii) the cyclohexyl(meth)acrylate is used in an amount of 1 to 40 percent by weight, such as 10 to 30 percent by weight, or, in some cases 10 to 20 percent by weight, wherein the weight percents are based on the total weight of reactants used to manufacture the latex.

In certain embodiments, the reactants used to manufacture the latex used in certain compositions of the present invention comprises a polyether(meth)acrylate. As used herein, the term “polyether(meth)acrylate” refers to a compound that includes more than one ether group per molecule and at least one (meth)acrylate group per molecule, such as compounds represented by the general structure (VIII):

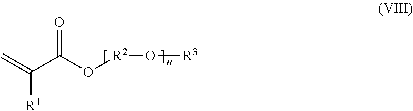

wherein: (a) R¹ is hydrogen or a methyl group; (b) each R², which can be the same or different, is a branched or linear alkyl group comprising 1 to 5 carbon atoms; (c) R³ is hydrogen or a saturated or unsaturated alkyl, alkylphenyl, or alkylether group; and (d) n is an integer having a value of 2 to 100, such as 5 to 60 or 40 to 60.

Specific examples of polyether(meth)acrylates, which are suitable for use in embodiments of the present invention, include, but are not limited to, monoacrylates having alkoxylated chains, such as an ethoxy or polyethylene oxide structure, including polyethylene glycol mono(meth)acrylates, such as methoxy polyethyleneglycol(meth)acrylate (e.g. Photomer 8061, Photomer 4960, Bisomer S20W and Bisomer PPA6 from Cognis Corp.; Miramer M1602 from Miwon Commercial Co., Ltd.; and SR604, CD513 and CD611 from Sartomer Co.), poly(tetrahydrofuran)(meth)acrylates; ethoxy ethoxyethyl acrylate (EOEOEA), ethyltriethylene glycol methacrylate, ethoxylated phenoxy ethyl acrylate, monomethoxy neopentyl glycol propoxylate monoacrylate (Photomer 8127 from Henkel); and mono or multi acrylates having alkoxylated chains, such as an ethoxy or poly ethylene oxide structure, as well as combinations thereof.

In certain embodiments, the polyether(meth)acrylate is used in an amount of up to 10 percent by weight, such as up to 5 percent by weight, based on the total weight of reactants used to manufacture the latex present in certain compositions of the present invention. In certain embodiments, the polyether(meth)acrylate is used in an amount of at least 0.1 percent by weight, such as at least 0.5 percent by weight or at least 1 percent by weight based on the total weight of reactants used to manufacture the latex used in certain compositions of the present invention.

In addition to the foregoing, other reactants may be used to form the latex present in certain compositions of the present invention. For example, in certain embodiments, the reactants may further comprise a water soluble ethylenically unsaturated compound, such as, for example, an acid-containing compound, such as a phosphorous containing acid, sulfur containing acid or carboxylic acid group containing compound, such as methacrylic acid and/or acrylic acid, among others.

In certain embodiments, the water soluble ethylenically unsaturated compound is used in an amount of 0.1 up to 2 percent by weight, based on the total weight of reactants used to manufacture the latex used in certain compositions of the present invention. In certain embodiments, the water soluble ethylenically unsaturated compound comprises acid groups and is used in an amount sufficient to provide the latex with 0.01 to 0.1 millequivalents acid per gram of polymer solids.

Other ethylenically unsaturated monomers suitable for use in preparing the latex used in certain compositions of the present invention include, without limitation, hydroxy-containing ethylenically unsaturated monomers (which are different from the aforementioned polyether(meth)acrylates that include hydroxyl groups) such as hydroxyethyl(meth)acrylates, hydroxylpropyl(meth)acrylates, and/or hydroxybutyl(meth)acrylates, and the like.

In certain embodiments, the hydroxy-containing ethylenically unsaturated monomer is used in an amount of up to 20 percent by weight, such as up to 15 percent by weight, based on the total weight of reactants used to manufacture the latex used in certain compositions of the present invention. In certain embodiments, the hydroxy-containing ethylenically unsaturated monomer is used in an amount of at least 1 percent by weight, such as at least 5 percent by weight, based on the total weight of reactants used to manufacture the latex used in certain compositions of the present invention.

In certain embodiments, the latex used in certain compositions of the present invention is formed from reactants comprising a plurality of monoethylenically unsaturated monomers, wherein the plurality of monoethylenically unsaturated monomers comprise, or, in some cases, consist essentially of (a) 0.1 to 10 percent by weight, such as 0.2 to 5 percent by weight, based on the total weight of reactants used to manufacture the latex, of a ureido-functional ethylenically unsaturated compound; (b) 0.1 to 10 percent by weight, such as 0.5 to 5 percent by weight, based on the total weight of reactants used to manufacture the latex, of an ethylenically unsaturated silicone; (c) 1 to 40 percent by weight, such as 10 to 30 percent by weight, based on the total weight of reactants used to manufacture the latex, of a vinyl aromatic compound; (d) 10 to 80 percent by weight, such as 30 to 70 percent by weight, based on the total weight of reactants used to manufacture the latex, of an alkyl(meth)acrylate; and, optionally, one or more of: (e) 1 to 20 percent by weight, such as 1 to 10 percent by weight, based on the total weight of reactants used to manufacture the latex, of a cycloaliphatic(meth)acrylate; (f) 0.1 to 10 percent by weight, such as 1 to 5 percent by weight, based on the total weight of reactants used to manufacture the latex, of a polyether(meth)acrylate; (g) 0.1 to 2 percent by weight, based on the total weight of reactants used to manufacture the latex, of an acid-containing ethylenically unsaturated compound; and (h) 1 to 20 percent by weight, such as 5 to 15 percent by weight, based on the total weight of reactants used to manufacture the latex, of a hydroxy-containing ethylenically unsaturated monomer.

In certain embodiments, the reactants used, and their respective amounts, are selected so as to provide acrylic copolymer particles having a calculated Tg of at least 0° C., or in some cases, at least 10° C., at least 15° C., or, in some cases, at least 20° C. In certain embodiments, the calculated Tg of these acrylic copolymer particles is no more than 60° C., such as no more than 40° C., or in some cases, no more than 30° C. or no more than 25° C. As used herein, the “calculated Tg” of a polymer refers to the Tg of a theoretical polymer formed from the selected monomers, in their selected amounts, calculated as described in “The Chemistry of Organic Film Formers,” D. H. Solomon, J. Wiley & Sons, New York, 1967, p. 29.

The latex can be prepared by emulsion polymerization of the polymerizable reactants mentioned above, such as is illustrated in the Examples. In certain embodiments, a surface active agent may be added to the aqueous continuous phase to stabilize, or prevent coagulation or agglomeration of the monomer droplets, especially during polymerization.

The surface active agent can be present at any level that stabilizes the emulsion. The surface active agent may be present in an amount of at least 0.001 percent by weight, such as at least 0.005 percent by weight, at least 0.01 percent by weight, or at least 0.05 percent by weight, based on the total weight of the emulsion. The surface active agent may be present in an amount of up to 10 percent by weight, such as up to 7.5 percent by weight, up to 5 percent by weight, or in some cases up to 3 percent by weight based on the total weight of the emulsion. The level of the surface active agent used is determined by the amount required to stabilize the emulsion.

The surface active agent may be an anionic, cationic, reactive or nonionic surfactant, or a compatible mixture thereof, such as a mixture of an anionic and a nonionic surfactant. Suitable cationic dispersion agents that may be used include, but are not limited to, lauryl pyridinium chloride, cetyldimethyl amine acetate, and alkyldimethylbenzylammonium chloride, in which the alkyl group has from 8 to 18 carbon atoms.

Suitable anionic dispersing agents include, but are not limited to, alkali fatty alcohol sulfates, such as sodium lauryl sulfate (Duponol C or QC from Du Pont), and the like; arylalkyl sulfonates, such as potassium isopropylbenzene sulfonate, and the like; alkali alkyl sulfosuccinates, such as sodium octyl sulfosuccinate, and the like; and alkali arylalkylpolyethoxyethanol sulfates or sulfonates, such as sodium or ammonium octylphenoxypolyethoxyethyl sulfate or sodium or ammonium nonylphenoxypolyethoxyethyl sulfate, having 1 to 50 oxyethylene units; sodium or ammonium mixed long chain alcohol sulfates available from Du Pont under the designation Duponol WN, sodium octyl sulfate available from Alcolac, Ltd. under the designation Sipex OLS, sodium tridecyl ether sulfate (Sipex EST), sodium lauryl ether sulfate (Sipon ES), magnesium lauryl sulfate (Sipon LM), the ammonium salt of lauryl sulfate (Sipon L-22), diethanolamino lauryl sulfate (Sipon LD), sodium dodecylbenzene sulfonate (SIPONATE® DS), the sodium laureth sulfate, magnesium laureth sulfate, sodium laureth-8 sulfate, magnesium laureth-8 sulfate mixture sold under the name of Texapon ASV by Cognis; the sodium lauryl ether sulfate (C₁₂₋₁₄ 70/30) (2.2 EO) sold under the names Sipon AOS 225 or Texapon N702 Paste by Cognis; the ammonium lauryl ether sulphate (C₁₂₋₁₄ 70/30) (3 EO) sold under the name Sipon Lea 370 by Cognis; and/or the ammonium (C₁₂₋₁₄) alkyl ether (9 EO) sulfate sold under the name Rhodapex AB/20 by Rhodia Chimie.

Reactive surfactants are suitable for use, often in combination with one or more of the aforementioned anionic surfactants. Examples of such reactive emulsifiers include reactive anionic surfactants, sulfosuccinate reactive anionic surfactants, and alkenyl succinate reactive anionic surfactants. Examples of commercially available sulforsuccinate reactive anionic surfactants are LATEMUL S-120, S-120A, S-180 and S-180A (tradename, products of Kao Corp.) and ELEMINOL IS-2 (tradename, product of Sanyo Chemical Industries, Ltd.). An example of a commercially available alkenyl succinate reactive anionic surfactant is LATEMUL ASK (tradename, product of Kao Corp.). Other suitable reactive surfactants are C₃₋₅ aliphatic unsaturated carboxylic acid sulfoalkyl (containing 1 to 4 carbon atoms) ester surfactants, for example, (meth)acrylic acid sulfoalkyl ester salt surfactants such as 2-sulfoethyl(meth)acrylate sodium salt and 3-sulfopropyl(meth)acrylate ammonium salt; and aliphatic unsaturated dicarboxylic acid alkyl sulfoalkyl diester salt surfactants such as sulfopropylmaleic acid alkyl ester sodium salt, sulfopropylmaleic acid polyoxyethylene alkyl ester ammonium salt and sulfoethylfumaric acid polyoxyethylene alkyl ester ammonium salt; maleic acid dipolyethylene glycol ester alkylphenolether sulfates; phthalic acid dihydroxyethyl ester(meth)acrylate sulfates; 1-allyloxy-3-alkyl phenoxy-2-polyoxyethylene sulfates (tradename: ADEKA REASOAP SE-10N, product of ADEKA Corp.), polyoxyethylene alkylalkenylphenol sulfates (tradename: AQUALON, product of DAI-ICHI KOGYO SEIYAKU CO., LTD.), and ADEKA-REASOAP SR-10 (EO number of moles=10, product of ADEKA Corp.), SR-20 (EO number of moles=20, product of ADEKA Corp.), and SR-30 (EO number of moles=30, product of ADEKA Corp.).

Suitable non-ionic surface active agents include but are not limited to alkyl phenoxypolyethoxy ethanols having alkyl groups of from about 7 to 18 carbon atoms and from about 1 to about 60 oxyethylene units such as, for example, heptyl phenoxypolyethoxyethanols; ethylene oxide derivatives of long chained carboxylic acids such as lauric acid, myristic acid, palmitic acid, oleic acid, and the like, or mixtures of acids such as those found in tall oil containing from 1 to 60 oxyethylene units; ethylene oxide condensates of long chained alcohols such as octyl, decyl, lauryl, or cetyl alcohols containing from 1 to 60 oxyethylene units; ethylene oxide condensates of long-chain or branched chain amines such as dodecyl amine, hexadecyl amine, and octadecyl amine, containing from 1 to 60 oxyethylene units; and block copolymers of ethylene oxide sections combined with one or more hydrophobic propylene oxide sections. High molecular weight polymers such as hydroxyethyl cellulose, methyl cellulose, polyacrylic acid, polyvinyl alcohol, and the like, may be used as emulsion stabilizers.

A free radical initiator often is used in the emulsion polymerization process. Any suitable free radical initiator may be used. Suitable free radical initiators include, but are not limited to thermal initiators, photoinitiators and oxidation-reduction initiators, all of which may be otherwise categorized as being water-soluble initiators or non-water-soluble initiators.

Examples of thermal initiators include, but are not limited to, azo compounds, peroxides and persulfates. Suitable persulfates include, but are not limited to sodium persulfate and ammonium persulfate. Oxidation-reduction initiators may include, as non-limiting examples persulfate-sullfite systems as well as systems utilizing thermal initiators in combination with appropriate metal ions such as iron or copper.

Suitable azo compounds include, but are not limited to, non-water-soluble azo compounds such as 1-1′-azobiscyclohexanecarbonitrile, 2-2′-azobisisobutyronitrile, 2-2′-azobis(2-methylbutyronitrile), 2-2′azobis(propionitrile), 2-2′-azobis(2,4-dimethylvaleronitrile), 2-2′azobis(valeronitrile), 2-(carbamoylazo)-isobutyronitrile and mixtures thereof; and water-soluble azo compounds such as azobis tertiary alkyl compounds include, but are not limited to, 4-4′-azobis(4-cyanovaleric acid), 2-2′-azobis(2-methylpropionamidine)dihydrochloride, 2, 2′-azobis[2-methyl-N-(2-hydroxyethyl)propionamide], 4,4′-azobis(4-cyanopentanoic acid), 2,2′-azobis(N,N′-dimethyleneisobutyramidine), 2,2′-azobis(2-amidinopropane)dihydrochloride, 2,2′-azobis(N,N′-dimethyleneisobutyramidine)dihydrochloride and mixtures thereof.

Suitable peroxides include, but are not limited to hydrogen peroxide, methyl ethyl ketone peroxides, benzoyl peroxides, di-t-butyl peroxides, di-t-amyl peroxides, dicumyl peroxides, diacyl peroxides, decanol peroxide, lauroyl peroxide, peroxydicarbonates, peroxyesters, dialkyl peroxides, hydroperoxides, peroxyketals and mixtures thereof.

The emulsion described above may also contain a neutralizing agent when the latex is formed from an ionic reactant, such as the acid functional monomers described above. In such an instance, the neutralizing agent is often a base. Suitable bases include inorganic and organic bases. Suitable inorganic bases include the full range of the hydroxide, carbonate, bicarbonate, and acetate bases of alkali or alkaline metals. Suitable organic bases include ammonia, primary/secondary/tertiary amines, diamines, and triamines. The amount of neutralizing agent required is typically determined on a molar basis of neutralizing agent to polymerized ionic monomer units of the latex. In certain embodiments, the polymerized ionic monomer units are at least 50%, at least 80%, or, in some cases, at least 90% neutralized.

In certain embodiments, the latex is prepared by a seeded emulsion polymerization process. In such a process a portion of the reactants are polymerized using a portion of the free radical initiator to form polymeric seeds dispersed in the continuous phase. Thereafter, the remainder of the initiator is added and the remainder of the reactants is polymerized in the presence of the dispersed polymeric seeds to form the latex. If an ionic reactant was used, a neutralizing agent may then be added to neutralize at least a portion of the ionic groups. Such neutralization can be conducted at elevated temperatures, such as 50-80° C. or it can be conducted after cooling the emulsion to approximately room temperature, i.e., 25-30° C.

In certain embodiments, the latex particles have a size that is uniformly small, i.e., after polymerization less than 20 percent of the latex particles have a particle size of greater than 5 micron, or, in some cases, 1 micron. In certain embodiments, the latex particles have a mean particle size of no more than 1 micron, such as no more than 900 nanometers, no more than 800 nanometers, no more than 500 nanometers, no more than 400 nanometers, or, in some cases, no more than 300 nanometers or no more than 200 nanometers. Moreover, in certain embodiments, the latex particles have a mean particle size of at least 1 nanometer, such as greater than 5 nanometers, greater than 10 nanometers, greater than 20 nanometers, or, in some cases, greater than 50 nanometers. The latex particle diameter can be measured by photon correlation spectroscopy as described in International Standard ISO 13321. The average particle diameter values reported herein are measured by photon correlation spectroscopy using a Malvern Zetasizer 3000HSa according to the following procedure. Approximately 10 mL of ultra filtered deionized water and 1 drop of a homogenous test sample are added to a clean 20 mL vial and then mixed. A cuvet is cleaned and filled with ultrafiltered deionized water, to which about 3-6 drops of the diluted sample is added. Once any air bubbles are removed, the cuvet is placed in the Zetasizer 3000HSa to determine if the sample is of the correct concentration using the Correlator Control window in the Zetasizer Software (100 to 200 KCts/sec). Particle size measurements are then made with the Zetasizer 3000HSa.

In certain embodiments, the compositions of the present invention also comprise a colorant and/or filler. As used herein, “colorant” means any substance that imparts color and/or opacity and/or other visual effect to the composition. A “filler”, on the other hand, does not necessarily impart any color and/or opacity and/or other visual effect to the composition. Suitable colorants include, for examples, pigments (organic or inorganic) and dyes. Inorganic pigments and/or fillers include metal oxides, such as the oxides of iron, titanium, zinc, cobalt, and chrome. Earth colors may employ mineral pigments obtained from clay. Various forms of carbon may be used for black coloration. Organic pigments are typically insoluble and are derived from natural or synthetic materials, and include phthalocyanine, lithos, toluidine, and para red. Organic pigments may be employed in a precipitated form as a flake. Dyes encompass a wide variety of organic materials that may be used in stain compositions, e.g., acid dyes. Dyes that are water soluble particularly lend themselves to use in the present invention.

In certain embodiments, the colorant and/or filler comprises a nanoparticle dispersion. Nanoparticle dispersions can include colorant or filler particles, such as any of the inorganic or organic materials described above, having a particle size of less than 150 nanometers, such as less than 70 nanometers, or less than 30 nanometers. Nanoparticles can be produced by milling stock organic or inorganic particles with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution).

In order to minimize re-agglomeration of nanoparticles within the composition and resulting coating, an aqueous dispersion of resin-coated nanoparticles can be used. As used herein, an “aqueous dispersion of resin-coated nanoparticles” refers to a continuous phase comprising water in which is dispersed discreet “composite microparticles” that comprise a nanoparticle and a resin coating on the nanoparticle. Example dispersions of resin-coated nanoparticles and methods for making them are identified in U.S. Pat. No. 7,605,194 at col. 3, line 56 to col. 16, line 25, the cited portion of which being incorporated herein by reference. As used herein, “nanoparticles” refers to particles that have an average particle size of less than 1 micron. In some embodiments, the nanoparticles used in the present invention have an average particles size of 300 nanometers or less, such as 200 nanometers or less, or, in some cases, 100 nanometers or less.

In fact, it has been discovered that the use of such dispersions of resin-coated nanoparticles in low VOC waterborne stain and sealant compositions, such as those comprising a latex polymer, such as the latexes described herein, can improve the anti-settling capability, color consistency and shelf-life of such compositions. Furthermore, it is believed that the use of such dispersions of resin-coated nanoparticles can improve other of properties of such compositions, such as their UV durability.

As a result, the present invention is also directed to methods for treating a porous substrate, such as wood, with a waterborne, sometimes translucent, composition comprising an aqueous dispersion comprising: (a) polymer, such as acrylic polymer (such as the acrylic polymers described above), particles; and (b) resin-coated nanoparticles, such as resin-coated metal oxide nanoparticles, such as the oxides of iron, titanium, zinc, cerium and/or cobalt.

In certain embodiments, the stain compositions of the present invention comprise 0.1 up to 30 percent by weight of the colorant and/or filler, or, in some embodiments, 1 up to 6 percent by weight of the colorant and/or filler, based on the total weight of the composition.

In addition, the compositions of the present invention can contain other optional ingredients including ultraviolet (“UV”) absorbers, plasticizers, flow control agents, surfactants and other known formulating additives. Indeed, in some cases, the latex itself can prepared from a reactant comprising an ethylenically unsaturated monomer comprising a UV absorbing group, such as is the case with 2-hydroxy-5-(methacryloxyethyl)phenyl-2H-benzotriazole, commercially available as TINUVIN R796 from Ciba Specialty. In certain embodiments, an antiskin agent, such as methyl ethyl ketoxime may be added to, for example, improve package stability. In some cases, fillers and flatting agents, such as clay, talc, silica, and the like can be added. Suitable silicas are commercially available from W.R. Grace and Company as SYLOID 169 and from DeGussa Corporation as AEROSIL 972. Sag resistance additives, such as cellulose acetate butyrate 551-0.2 from Eastman Chemicals can also be included, as can other additives that enhance properties. A hydrophobic agent, such as a silicone-based material (e.g., a silane, siloxane, or silicone-resin matrix), can be included to improve the water resistance of the composition. Various additives, when used, typically comprise no more than 30 weight percent, such as no more than 10 weight percent, of the coating composition based on the total weight of the composition.

The compositions of the present invention can be applied to any of a variety of substrates, which may or may not have a preexisting stain or coating deposited thereon. In certain embodiments, the compositions of the present invention are applied to a porous substrate, such as paper, cardboard, particle board, fiber board, wood, wood veneers, and wood composite hybrids. Various woods that can be stained with the present compositions include, for example, oak, cherry, pine, cedar, redwood, and maple. These types of woods are used in the preparation of, for example, decking, wood siding, kitchen cabinets, bath cabinets, tables, desks, dressers, and other furniture, as well as flooring, such as hardwood and parquet flooring. In some embodiments, the substrate comprises treated wood, which, as used herein, refers to wood that has been treated with a chrome-free copper containing wood preservative, such as ACQ or CA.

The compositions of the present invention can be applied to the substrate by any means known in the art. For example, they can be applied by brushing, wiping, dipping, flow coating, roll coating and conventional and electrostatic spraying.

Once applied, certain embodiments of the compositions of the present invention are allowed to soak into the porous substrate for a predetermined amount of time, and, in embodiments of the present invention wherein the composition is embodied as a wiping stain or sealant, the excess stain wiped off. Multiple layers can be applied.

As will be appreciated, particularly in the treatment of wood substrates, additional layers such as a topcoat may be applied over the top of a stain and/or sealant layer comprising a waterborne composition of the present invention. Therefore, certain embodiments of the present invention are directed to substrates at least partially coated with a multi-layer composite coating system. As used herein, the term “multi-layer composite coating system” refers to coating system that contains at least two coating layers applied successively over a substrate, such as a porous substrate.

Whereas particular embodiments of this invention have been described above for purposes of illustration, it will be evident to those skilled in the art that numerous variations of the details of the present invention may be made without departing from the invention as defined in the appended claims.

Illustrating the invention are the following examples that are not to be considered as limiting the invention to their details. All parts and percentages in the examples, as well as throughout the specification, are by weight unless otherwise indicated.

### EXAMPLE 1

Latex dispersions were made using the ingredients and amounts identified in Table 1 according to the procedure that follows. A reaction flask was equipped with a stirrer, thermocouple, nitrogen inlet, and a condenser. Charge A was then added and stirred with heat to 80° C. under nitrogen atmosphere. Pre-emulsions of Feed A and Feed C were prepared by mixing all the ingredients for 20 minutes. To charge A at 80° C., Feed A was added and stirred for 5 minutes. Feed B was added and stirred for 30 minutes. Then, pre-emulsion Feed C and initiator Feed D were simultaneously added over three hours to the reaction mixture. The reaction mixture was stirred at 80° C. for an hour and subsequently cooled to 50° C. Then, Feed E was added over five minutes followed by Feed F was added over five minutes. The latex dispersion was stirred for 15 minutes and filtered through 5 micron filter bags.

TABLE 1

| | Example | Example | Example | Example |
|---|---|---|---|---|
| | 1A | 1B | 1C | 1D |
| Charge A | | | | |
| (weight in grams) | | | | |
| Deionized water | 677.5 | 677.6 | 677.9 | 677.4 |
| N,N-Dimethyl | 1.09 | 1.2 | 1.06 | 1.14 |
| ethanolamine | | | | |
| Alipal CO436¹ | 5.58 | 5.78 | 5.44 | 5.57 |
| Feed A | | | | |
| 2-Hydroxyethyl | 1.44 | 1.47 | 1.41 | 1.51 |
| methacrylate | | | | |
| Methylmethacrylate | 6.09 | 5.99 | 6.02 | 6.03 |
| Styrene | 2.85 | 2.84 | 2.86 | 2.97 |
| Cyclohexyl methacrylate | 0.93 | 0.93 | 0.93 | 0.97 |
| 2-ethyl hexyl acrylate | 2.89 | 2.92 | 2.85 | 2.85 |
| Methacrylic acid | 0.12 | 0.12 | 0.13 | 0.15 |
| Alipal CO 436¹ | 0.29 | 0.31 | 0.29 | 0.29 |
| Igepal CO430² | 0.06 | 0.07 | 0.62 | 0.07 |
| Deionized water | 5.37 | 5.38 | 5.45 | 5.36 |
| Feed B weight in grams) | | | | |
| De-ionized water | 12.6 | 12.94 | 12.59 | 12.64 |
| Ammonium persulfate | 1.32 | 1.36 | 1.35 | 1.33 |
| Feed C (weight in grams) | | | | |
| 2-Hydroxyethyl | 75.71 | 75.54 | 75.43 | 75.42 |
| methacrylate | | | | |
| Methylmethacrylate | 116.57 | 116.6 | 116.53 | 116.43 |
| n-Butyl methacrylate | 211.51 | 178.74 | 220.41 | 187.2 |
| Styrene | 148.86 | 149.14 | 148.74 | 149.11 |
| Cyclohexyl methacrylate | 48.95 | 48.97 | 48.81 | 48.77 |
| Bisomer S20W³ | 40.39 | 40.74 | 40.5 | 40.49 |
| 2-ethyl hexyl acrylate | 149.35 | 149.30 | 149.34 | 149.28 |
| Silmer ACR DI-50⁴ | 0.0 | 33.0 | 0.0 | 33.04 |
| Sipomer WAM II⁵ | 16.45 | 16.58 | 0.0 | 0.0 |
| Methacrylic acid | 3.04 | 3.01 | 6.4 | 6.47 |
| Alipal CO 436¹ | 29.62 | 29.56 | 29.42 | 29.53 |
| Igepal CO430² | 2.82 | 2.8 | 2.99 | 2.94 |
| Deionized water | 281.14 | 280.71 | 286.24 | 285.58 |
| Feed D (weight in grams) | | | | |
| De-ionized water | 185.35 | 185.28 | 185.1 | 185.21 |
| Ammonium persulfate | 2.53 | 2.53 | 2.55 | 2.58 |
| Feed E (weight in grams) | | | | |
| N,N-Dimethyl | 4.43 | 4.47 | 4.44 | 4.29 |
| ethanolamine | | | | |
| De-ionized water | 14.74 | 14.73 | 14.77 | 14.91 |
| Feed F (weight in grams) | | | | |
| De-ionized water | 4.60 | 4.85 | 4.71 | 4.72 |
| Acticide MBS⁶ | 5.03 | 5.02 | 5.1 | 5.15 |
| % solids | 40.17 | 40.17 | 39.2 | 40.26 |
| pH | 8.18 | 8.33 | 8.68 | 8.6 |

¹Surfactant available from Rhodia, Inc
²Surfactant available from Rhodia, Inc
³Monomer available from Cognis Corporation
⁴Monomer available from Siltech Corporation
⁵Monorner available from Rhodia, Inc
⁶Biocide available from Thor Specialties, Inc

### EXAMPLE 2

Stain compositions were prepared by adding the components listed in Table 2 in order to a suitable vessel with agitation. Amounts are in grams.

TABLE 2

| | Example | Example | Example | Example |
|---|---|---|---|---|
| Ingredient | 2A | 2B | 2C | 2D |
| Example 1A Latex | 400.449 | | | |
| Example 1B Latex | | 400.672 | | |
| Example 1C Latex | | | 409.1 | |
| Example 1D Latex | | | | 397.94 |
| Tap Water | 100 | 100 | 100 | 100 |
| Diethylene Glycol | 32 | 32 | 32 | 32 |
| Monobutyl Ether¹ | | | | |
| Tap Water | 10 | 10 | 10 | 10 |
| Triton ® GR7M | 32 | 32 | 32 | 32 |
| Wetting Additive¹ | | | | |
| Trans-Oxide ® Yellow² | 15 | 15 | 15 | 15 |
| Trans-Oxide ® Red² | 5 | 5 | 5 | 5 |
| Trans-Oxide ® Black² | 2.8 | 2.8 | 2 | 2.8 |
| Tap Water | 258.231 | 258.897 | 250.059 | 259.755 |
| Total | 855.48 | 856.369 | 855.126 | 854.494 |
| VOC, g/l³ | 207.47 | 208 | 207.72 | 206.86 |

¹Available from DOW Chemical Co.
²Pigment dispersion available from Emerald Performance Materials
³Calculated according to the equation: VOC = grams VOC/(liters paint − liters water).

### Testing

### Water Resistance

Compositions 2A-2D were applied at a natural spreading rate by nylon/polyester brush to new pressure treated wood boards. The panels were then air dried overnight under ambient laboratory conditions. Droplets of tap water, the size of a dime, were pipeted on to the stained wood substrate at room temperature. The droplets were monitored every 15 minutes for 8 hours or until they completely disappeared either by entering the wood or by evaporation. The duration for the water droplet to disappear was noted in minutes. Results are set forth in Table 3.

TABLE 3
Water Resistance
(Length of time composition held out water, in minutes)¹

| | |
|---|---|
| Example 2A | 25.0 |
| Example 2B | 38.3 |
| Example 2C | 25.0 |
| Example 2D | 31.7 |

¹Reported results are an average of three samples.

### Wet Adhesion (Humidity Resistance)

Adhesion of compositions 2A-2D to new southern yellow pine wood boards was evaluated using a cross (X) cut test in accordance with ASTM D 3359-09, Test Method A. The stained wood was cut into a cross using a cutter (common razorblade). The adhesion test was carried out after conditioning the coated wood for 4 days in a humidity chamber (manufactured by Auto Technology model number 23A). The operating conditions of the chamber were as follows: temperature 100° F., humidity 100%. The samples were laid down or on their sides with the face carrying the coating facing up. A strip of adhesive tape (Permacel P-99) was applied and then withdrawn, allowing the non adhesive portion of the coating to be lifted. In Table 4 below, the wet adhesion is reported as a whole number between 1 to 10, with 10 denoting no adhesion loss and 1 denoting total adhesion loss.

TABLE 4
Wet Adhesion: Cross cut test¹

| | |
|---|---|
| Example 2A | 9.0 |
| Example 2B | 9.7 |
| Example 2C | 6.7 |
| Example 2D | 8.0 |

¹Reported results are an average of three samples.

### EXAMPLE 3

Stain compositions were prepared by adding the components listed in Table 5 in order to a suitable vessel with agitation. Amounts are in grams.

TABLE 5

| | Example | Example | Example | Example |
|---|---|---|---|---|
| Ingredient | 3A | 3B | 3C | 3D |
| Acrylic Latex¹ | 400.672 | 400.672 | 400.672 | 400.672 |
| Tap Water | 100.000 | 100.000 | 100.000 | 100.000 |
| Diethylene glycol | 32.000 | 32.000 | 32.000 | 32.000 |
| monobutyl ether² | | | | |
| Tap Water | 10.000 | 10.000 | 10.000 | 10.000 |
| Wetting Agent³ | 32.000 | 32.000 | 32.000 | 32.000 |
| Trans-Oxide ® | 20.000 | — | — | — |
| Red Tint⁴ | | | | |
| Resin-Coated | — | 52.900 | — | — |
| Nanoparticle Red Tint⁵ | | | | |
| Trans-Oxide ® | — | — | 20.000 | — |
| Yellow Tint⁶ | | | | |
| Resin-Coated | — | — | — | 44.870 |
| Nanoparticle Yellow | | | | |
| Tint⁷ | | | | |
| Tap Water | 261.004 | 227.709 | 260.754 | 235.690 |
| Total | 855.676 | 855.281 | 855.426 | 855.232 |

¹Acrylic resin derived from 1% ureido-functional ethylenically unsaturated compound (Sipomer WAM II) and 4% ethylenically unsaturated silicone (Silmer ACR DI-50), based on total monomer weight, prepared in a manner similar to that described in Example 1.
²Available from Dow Chemical Co.
³Triton GR7M from Dow Chemical Co.
⁴Super Seatone Aqueous Dispersion code 6C-11-B143 from Emerald Performance Materials.
⁵A mixture of 656.64 pounds of a polyurethane dispersion, 0.087 pounds of hydroquinone monomethyl ether, 97.416 pounds of Trans-Oxide ® Red 10-30-AC-1005 from Rockwood Pigments, and 170.478 pounds of deionized water was prepared. The polyurethane dispersion was an aqueous dispersion of a polyurethane (meth)acrylate resin and (meth)acrylate monomer comparable to that described in Example 1 of U.S. Pat. No. 7,605,194. The mixture was milled on a basket mill containing 75%1.2-1.7 mm Zirconex for 60 minutes. The pre-milled mixture was then run through an Eiger containing 80% 0.3 mm YTZ Zirconox media for 60 minutes.
⁶Super Seatone Aqueous Dispersion code 6C-11-B243 from Emerald Performance Materials.
⁷A mixture of 573 pounds of a polyurethane dispersion, 0.072 pounds of hydroquinone monomethyl ether, 120 pounds of Trans-Oxide ® Yellow GS 10-30-AC-0544 from Rockwood Pigments, and 237.85 pounds of deionized water was prepared. The polyurethane dispersion was an aqueous dispersion of a polyurethane (meth)acrylate resin and (meth)acrylate monomer comparable to that described in Example 1 of U.S. Pat. No. 7,605,194. The mixture was milled on a basket mill containing 75%1.2-1.7 mm Zirconex for 60 minutes. The pre-milled mixture was then run through an Eiger containing 80% 0.3 mm YTZ Zirconox media for 60 minutes.

### EXAMPLE 4

Stain compositions were prepared by adding the components listed in Table 6 in order to a suitable vessel with agitation. Amounts are in grams.

TABLE 6

| | Example | Example | Example | Example |
|---|---|---|---|---|
| Ingredient | 4A | 4B | 4C | 4D |
| Alkyd Resin⁹ | 431.450 | 431.450 | 431.450 | 431.450 |
| Tap Water | 100.000 | 100.000 | 100.000 | 100.000 |
| Cobalt Drier¹⁰ | 1.920 | 1.920 | 1.920 | 1.920 |
| Tap Water | 10.000 | 10.000 | 10.000 | 10.000 |
| Trans-Oxide ® Red | 20.000 | — | — | — |
| Tint⁴ | | | | |
| Resin-Coated | — | 52.900 | — | — |
| Nanoparticle Red Tint⁵ | | | | |
| Trans-Oxide ® Yellow | — | — | 20.000 | — |
| Tint⁶ | | | | |
| Resin-Coated | — | — | — | 44.870 |
| Nanoparticle Yellow | | | | |
| Tint⁷ | | | | |
| Tap Water | 290.076 | 256.781 | 289.826 | 264.761 |
| Total | 853.446 | 853.051 | 853.196 | 853.001 |

⁸CHEMPOL ® 821-2241 from Cook Composites & Polymers.
⁹Duroct ® cobalt 6% drier from Dura Chemical Inc.

### Testing

### Clarity

The compositions of Examples 3 and 4 were applied to 0.005 mil clear Dura-lar sheets by a 0.003 mil bird drawdown bar. Panels were then dried in an oven at 120° F. for 16 hours. Percent haze was measured with a Datacolor spectrophotometer. Results are in Table 7.

TABLE 7

| Example | % Haze |
|---|---|
| 3A | 9.27 |
| 3B | 4.83 |
| 3C | 12.87 |
| 3D | 4.45 |
| 4A | 28.85 |
| 4B | 22.91 |
| 4C | 49.41 |
| 4D | 48.70 |

### Stability

The compositions of Examples 3 and 4 were placed at lab conditions (ambient conditions) for four weeks and allowed to settle. Ash analysis of supernat liquid and sediment was completed using a quarts crucible. Results are set forth in Table 8.

TABLE 8

| | % Pigment in | % Pigment Of Tint |
|---|---|---|
| Example | Supernat Liquid | in Sediment |
| 3A | 8372 ppm | 1.59% |
| 3B | 6840 ppm | 6917 ppm |
| 3C | 8840 ppm | 1.18% |
| 3D | 7407 ppm | 9433 ppm |
| 4A | 1.07% | 5.77% |
| 4B | 1.06% | 2.44% |
| 4C | 1.38% | 2.70% |
| 4D | 1.20% | 2.52% |

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A waterborne composition comprising an aqueous dispersion comprising a latex, wherein the latex comprises a reaction product of reactants comprising:
(a) a ureido-functional ethylenically unsaturated compound;
(b) an ethylenically unsaturated silicone; and
(c) an ethylenically unsaturated compound different from (a) and (b).

2. The composition of claim 1, wherein the ureido-functional ethylenically unsaturated compound has the structure: 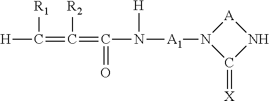
in which:
(a) R₁ and R₂ each independently represent hydrogen, a linear or branched alkyl group containing 1 to 6 carbon atoms, a cycloalkyl group containing 5 to 8 carbon atoms, or an aryl or aralkyl group containing 6 to 12 carbon atoms, optionally carrying an alkyl group containing 1 to 4 carbon atoms;
(b) A₁ and A each independently represent an alkylene group containing 2 to 4 carbon atoms optionally carrying an alkyl group containing 1 to 4 carbon atoms; and
(c) X is O or S.

3. The composition of claim 2, wherein:
(a) R₁ is hydrogen;
(b) R₂ is CH₃;
(c) A and A′ are both C₂H₄; and
(d) X is O.

4. The composition of claim 1, wherein the ureido-functional ethylenically unsaturated compound is present in an amount of 0.1 to 5 percent by weight, based on the total weight of the reactants.

5. The composition of claim 1, wherein ethylenically unsaturated silicone comprises a silicone(meth)acrylate.

6. The composition of claim 5, wherein the silicone(meth)acrylate comprises terminal (meth)acrylate groups.

7. The method of claim 6, wherein the silicone(meth)acrylate has the structure: 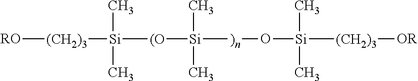
in which:
(a) each R is independently H, an alkyl group, a cycloalkyl group, an aryl group, an aralkyl group, or a group comprising a (meth)acrylate, with the proviso that at least one R is a group comprising a (meth)acrylate; and
(b) n is an integer having a value of 0 to 200.

8. The composition of claim 1, wherein the ethylenically unsaturated silicone is present in an amount of 0.1 to 10 percent by weight, based on the total weight of the reactants.

9. The composition of claim 1, wherein reactant (c) is selected from:
(a) a cycloaliphatic(meth)acrylate;
(b) a vinyl aromatic compound;
(d) an alkyl(meth)acrylate;
(e) a polyether(meth)acrylate;
(f) a (meth)acrylic acid;
(g) a hydroxyl-containing ethylenically unsaturated monomer; or
(f) a mixture of two or more thereof.

10. The composition of claim 1, wherein reactant (c) comprises a polyether(meth)acrylate.

11. The composition of claim 10, wherein reactant (c) further comprises a cycloaliphatic(meth)acrylate, a vinyl aromatic compound, and an alkyl(meth)acrylate.

12. A method of using the composition of claim 1, comprising depositing the composition upon a porous substrate.

13. The method of claim 12, wherein the porous substrate comprises treated wood.

14. A method for treating a porous substrate, comprising applying to the substrate a waterborne composition comprising an aqueous dispersion comprising:
(a) polymer particles; and
(b) resin-coated nanoparticles.

15. The method of claim 14, wherein the polymer particles comprise an acrylic polymer.

16. The method of claim 15, wherein the acrylic polymer particles comprise a reaction product of reactants comprising an ethylenically unsaturated silicone and/or a ureido-functional ethylenically unsaturated compound.

17. The method of claim 16, wherein the acrylic polymer particles comprise the reaction product of reactants comprising:
(a) a ureido-functional ethylenically unsaturated compound;
(b) an ethylenically unsaturated silicone; and
(c) an ethylenically unsaturated compound different from (a) and (b).

18. The method of claim 14, wherein the nanoparticles comprise metal oxide nanoparticles.

19. The method of claim 18, wherein the metal oxide nanoparticles comprise an oxide of iron, titanium, zinc, and/or cobalt.
